(19) United States
(12) Patent Application Publication
(10) Pub. No.: US 2009/0124284 A1
(43) Pub. Date: May 14, 2009

(54) SYSTEM AND METHOD FOR PROVIDING SEAMLESS BROADBAND INTERNET ACCESS TO WEB APPLICATIONS

(76) Inventors: Shimon Scherzer, Las Gatos, CA (US); Tamir Scherzer, Herzelia (IL)

Correspondence Address: NIXON PEABODY, LLP, 401 9TH STREET, NW, SUITE 900, WASHINGTON, DC, 20004-2128, US

(21) Appl. No.: 11/968,073

(22) Filed: Dec. 31, 2007

Related U.S. Application Data
(60) Provisional application No. 60/987,959, filed on Nov. 14, 2007.

(51) Int. Cl. H04M 1/00

(52) U.S. Cl. 455/552.1

(57) ABSTRACT

A WiFi communication framework that is particularly suitable for mobile devices. The framework provides comprehensive tools for establishing seamless Internet access for web applications on mobile handheld devices. In addition, it can provide user location to enable applications requiring such information. The framework may be implemented as a client on the handheld device. The broadband radio on the device is generally kept off. When the user activates an application requiring broadband service, communication protocol is established, causing the client to turn the broadband radio on and to establish connection to an available WiFi access point.

### RELATED APPLICATIONS

This Application claims priority from U.S. Application Ser. No. 60/987,959, filed Nov. 14, 2007, the entire disclosure of which is incorporated herein by reference.

### BACKGROUND

1. Field of the Invention

The general subject of the invention relates to enablement of rich content web applications on mobile devices such as dual mode smartphones.

2. Related Art

Recently there has been substantial movement of web applications from traditional static (desktop/laptop) environment to mobile devices. For example, YouTube, FaceBook, Google Earth etc., may be accessed by various PDA's, Smart Phones, and other such devices. In this context, laptop and notebook devices may be considered static devices, as during conventional use the device is static and is connected to a single wired or wireless Internet access point. On the other hand, when a handheld device is used in its conventionally manner, it is in motion and may need to change connection among several access points.

Web application normally depends on good broadband connection at home or work, which is normally satisfied by modestly priced cable or DSL service. Mobile web application requires high-speed access to the Internet in random locations, while maintaining modest cost and ease of use. To enable users to access the Internet using a handheld device, service providers commonly implement Internet access using the conventional cellular network (GPRS, 3G, WiMax). In their current deployment, the cellular networks provide good geographical coverage but have severely limited data capacity. To resolve this issue the cellular providers must increase their network deployment density by more than an order of magnitude (currently they support ˜10 Kbit/sec per subscriber while most data services require more than 100 Kb/s per subscriber). This network change will most likely result in a very substantial service-fees hike in order to cover the expense involved.

An alternative to the cellular data service can be provided by WiFi equipment that is already deployed in a very high density. Unfortunately, unlike cellular networks, most WiFi resources are not deployed as a managed network. For example, individuals and entities, such as coffee shops, airports, etc., may deploy WiFi equipment and enable patrons to access the Internet using their WiFi deployment. The use is either free or under a subscription charge. Since there is no centralized management of these access points, users normally do not know in advance the availability, quality, integrity, convenience, etc., of the available WiFi resources at a particular location. Moreover, there is no central network management that ensures the level of WiFi service at each location or assist users in properly connecting to such resources.

Current implementation of WiFi radios in mobile devices may cause severe battery drainage when the device is activated. That is, when the WiFi radio of a mobile device is turned on, it drains the battery at an increased rate, regardless of whether the user actually use the device to access the Internet. Furthermore, Internet usage is very bursty. That is, when a user wishes to view a page, the request comprises a relatively short uplink transmission. The response may or may not be a short downlink reception, but when it is completed the user may spend an elongated period reviewing the response—during which WiFi service may not be needed.

### SUMMARY

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Various embodiments of the subject invention provide a novel WiFi communication and location services framework that is particularly suitable for mobile devices. The framework is referred to herein as WeFi communication framework (WCF), and provides comprehensive tools for establishing seamless Internet access for web applications on mobile handheld devices. In addition, the WCF can provide users' location to enable applications requiring such information. WCF will automatically engage and disengage high speed WiFi communication facilities and rout application traffic through this facility following application request. By making sure that WiFi is activated only when it is really needed, device's battery power can be preserved. Application can retrieve the host terminals and other WCF using terminals' location information.

These capabilities are based on WCF's special functionality—leveraging users' community to enable easy finding, connecting and roaming in WiFi networks. WCF system architecture—client/server—enables web-application to engage local host's WiFi functionality by directly communicating with local host's WiFi server, by communicating with WCF server and/or by having the application web sever communicating with the WCF server as described below.

The WCF may be implemented as a client on the handheld device. Certain applications may recommend downloading WCF client in order to enhance their usability, similarly to Flash plug-in for graphic and video, Acrobat reader for PDF documents, etc. For example, if the application works better with WiFi as opposed to cellular network, requires user location information, or provides better user experience when WiFi and cellular connections are seamlessly interchanged, WCF use may be recommended by the application.

According to an aspect of the invention, a processor implemented method for connecting a wireless user device to the Internet is provided, the device comprising a WiFi radio and a cellular network transceiver, the method comprising operating the processor to perform the operations: monitoring application executing in the device for Internet access requirement; upon detecting Internet access requirement, evaluating the requirement to thereby determine whether to establish Internet connection using the WiFi radio or the cellular network transceiver; executing the connection to the Internet according to the determination. In the method, when determining that the Internet connection should be executed using the WiFi radio, performing the further steps: scanning for available WiFi access points; selecting an access point and attempting to connect to the access point using transmission from the broadband radio; and, if the attempt fails, attempting to connect to another access point, if the attempt is successful, maintaining the connection so long as access requirement is maintained. In the method, the Internet access requirement may be issued by the application and include a preference for WiFi connection. The method may further comprise monitoring reception at the device for a message indicating WiFi Internet access requirement. The monitoring reception may comprise receiving a message over a cellular network indicating a requirement for WiFi connection. Selecting an access point may comprise: sending data of available WiFi access points to a connection server; receiving a message from the connection server, the message including further data relating to the available WiFi access points; reading the further access point data from the message and connecting to the best available WiFi access point based on the data and the further data. Maintaining the connection may comprise monitoring a keep alive signal received at the device or at WiFi connection sever. The keep alive signal may be generated by the application. The method may further comprise, when no keep alive signal is detected for a predetermined period of time, terminating the connection to the access point and turning off the WiFi radio. Maintaining the connection may comprise monitoring broadband transmission activity of the device. The may further comprise, when no broadband transmission activity has been detected beyond a predetermined time period, automatically terminating the connection to the access point and turning off the WiFi radio. Maintaining the connection may comprise monitoring disconnection request issued by the application and, when a termination request has been received, automatically terminating the connection to the access point and turning off the WiFi radio. Maintaining the connection may comprise, when detecting unexpected connection drop, selecting another access point and attempting to connect.

According to aspect of the invention, in a communication system having an application server connected to the Internet, a network control sever that includes access point database connected to the Internet, and mobile device, the mobile device running a client in communication with the network control server, the mobile device comprising a cellular transceiver for connection to a cellular network and a WiFi radio for connecting to WiFi access points, a method of managing communication is provided, comprising upon detecting a high bandwidth transaction, performing one or more of the operations:

i. sending a connection request from the application server to the network control server, indicating WiFi connection requirement; upon receiving the connection request at the network control server, sending connection instruction, over the cellular network, to the device; upon receiving the connection instruction at the device, turning on the WiFi radio at the device and attempting to connect to a broadband access point;

ii. sending a connection request from a web application, running in web browser on the mobile device, directly to network control server; upon receiving the connection request at the network control server, sending connection instruction, over the cellular network, to the device; upon receiving the connection instruction at the device, turning on the WiFi radio at the device and attempting to connect to a broadband access point; and,

iii. sending a connection request from a web application, running in web browser on the mobile device, directly to the client; upon receiving the connection requet at the client, turning on the WiFi radio at the device and attempting to connect to a broadband access point. The method may further comprise when an application requiring high transmission rate is launched on the mobile device, sending a message, over the cellular network, from the mobile device to the application server indicating broadband connection requirement. The method may further comprise monitoring broadband transmission activity by the mobile device and, so long is broadband transmission activity is detected, sending a keep alive connection message from at least one of: the application server to the network control server; and the web application to the client. The method may further comprise sending from the network control sever a cookie with device ID to mobile device and wherein the connection request comprises data from the cookie. The method may further comprise monitoring broadband transmission activity by the mobile device and, when no activity is detected over a predetermined period, sending turn off instruction from the network control server to the mobile device. The method may further comprise, upon receiving the turn off instruction at the device, terminating the connection to the access point and turning off the WiFi radio. The method may further comprise, when no broadband connection is available, sending a no connection message from the mobile device to the access point database server. The method may further comprise, upon receiving a no connection message at the network control server, causing the application server to communicate with the mobile device over the cellular network. The method may further comprise: sending a location request with mobile device ID from the application server or directly from web application to the network control server; using the ID at the network control server to determined the particular access point the mobile device is connected to; querying network control server to determine the location of the particular access point; sending the location to the application server.

According to aspects of the invention, a mobile device is provided, comprising:
a cellular network transceiver;
a broadband radio;
a processor;
a connection client causing the processor to perform the operations:
   monitoring the device for Internet access requirement;
   upon detecting Internet access requirement, turning on the broadband radio and scanning for available WiFi access points;
   selecting an access point and attempting to connect to the access point using transmission from the broadband radio; and,
      if the attempt fails, attempting to connect to another access point,
      if the attempt is successful, maintaining the connection so long as access requirement is maintained.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a general schematic illustrating system layout according to an embodiment of the invention.

FIG. 2 is a flow chart illustrating a method to be executed by a client, according to an embodiment of the invention.

FIG. 3 is a schematic illustrating a social network according to an embodiment of the invention.

FIG. 4 schematically illustrates a system architecture according to an embodiment of the invention.

FIG. 5, illustrates an example of an Internet connection procedure according to an embodiment of the invention.

FIG. 6 illustrates an example of WiFI connection maintenance according to an embodiment of the invention.

FIG. 7 illustrates an example of a roaming process according to an embodiment of the invention.

FIG. 8 illustrates a flow chart of a process according to an embodiment of the invention.

FIG. 9 illustrates a process according to an embodiment of the invention for maintenance of connection.

### DETAILED DESCRIPTION

Various embodiments of the invention provide methods and systems for enhancing broadband access experience of dual mode (WiFi and cellular) handheld devices using web applications. Enhancing user experience is achieved by seamlessly engaging and disengaging terminal's WiFi radio only when rich content traffic is transmitted. In addition, whenever web-application requires location it may capitalize on the system's knowledge of the host terminal and other WCF terminals whereabouts.

For a better understanding of the invention, the description starts with an overall description of the WiFi network solution description, and then turns to its utilization for handheld devices.

Turning to the experience of laptop users, in densely populated cities it is common that many radio access points are listed on a laptop's wireless network connections screen. However, as is well known, just because a radio access point is listed on the screen and shows several bars of reception strength doesn't mean that the access point is available for connection and/or access to the Internet. That is, even if the access point is listed as unsecured, the laptop may still be unable to connect to that AP. To make matters worse, it is not possible to know beforehand (for example, before arriving at that locale) whether the AP is available for connection or not. Consequently, at present time the only way to determine which AP is available is to try to connect to each AP listed until one successfully connects. Such a reiterative process is cumbersome, especially in densely populated areas, and requires certain level of expertise in operating a laptop or other wireless mobile device. Such problems are elegantly solved by various embodiments of the invention, as illustrated below.

According to various embodiments of the invention, methods and apparatus are provided that closely integrate historical data discovered by users' community (such as WiFi “hot-spots” locations and quality), with real time data acquired by individual users. Each user's device executes a program (e.g., a client) that uses the combined data to find usable radio resources and establish Internet connection through them. The system employs client/server architecture: each user operates a radio client that, besides connecting to the radio network, executes radio measurements and reports to the network server that shares this information with other user's clients. Since each user's client knows most of the network parameters (ahead of connection to a new network), the client may spend much less time determining these parameters; hence the connection process can be substantially expedited. Furthermore, users are continuously discovering new usable WiFi resources and verify known resources potential connection capabilities; this information can be used by other users when in reach of these resources or when planning where to get connected such that less connection discovery is needed.

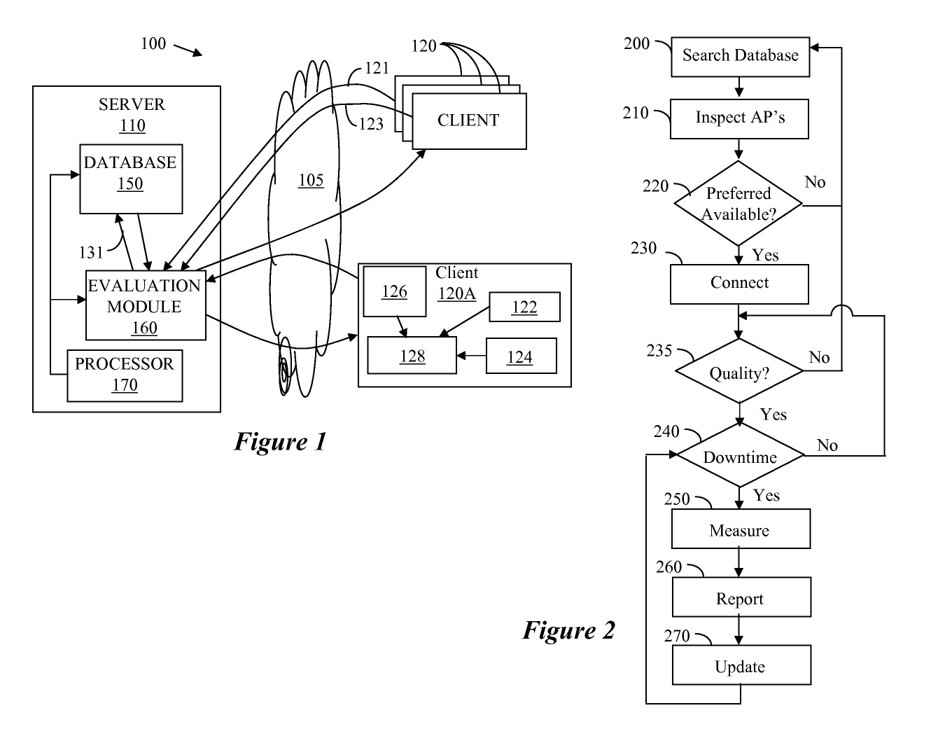

FIG. 1 is a general schematic illustrating a system layout according to an embodiment of the invention. In FIG. 1, various software clients in the terminals, herein “client”, 120 and 120A communicate with server 110 via network 105, such as the Internet. Client 120A (sometimes referred to herein as WeFi client) may be any of clients 120, and is provided to show greater details of various elements of clients 120. Server 110 (sometimes referred to herein as WeFi server) includes database 150, which stores historical data about radio broadband access resources. Server 110 also includes an evaluation module 160, which evaluates accessibility and bandwidth of various AP's, and stores the information as an update in database 110, as shown by arrow 131. A processor 170 controls the operations of the database 150 and evaluation module 160, and communication with the clients 120.

In one embodiment updates in the form of connectivity reports are sent to server 110 from each of the clients 120, as shown by arrows 121, 123. In another embodiment, the reports are sent only from clients residing on non-handheld devices; however, other functionalities and communication between a handheld-residing client 120 and server 110 still apply. The updates include data collected when each client attempts to connect to an access point (whether successful or not). Certain elements of clients 120 are depicted in exemplary client 120A. As shown in FIG. 1, according to this embodiment, client 120A comprises a credentials module 122, a local database 124, fast varying data module 126, and connection decision module 128. The functionality of these elements will be described below with respect to a method implemented according to an embodiment of the invention.

FIG. 2 is a flow chart illustrating a method to be executed by a client, according to an embodiment of the invention. This method may apply to any client or only to non-handheld residing clients. While the steps illustrated in FIG. 2 and described herein are in certain order, it should be appreciated that the various steps may be performed in a different order. In order to connect to a broadband network, in Step 200 the client 120A queries its local database 126 to obtain the best available AP for the particular location the clients is located at. At Step 210 the client inspects all available radio signals in the area. Then, at Step 220 the client checks whether the preferred AP for that location is available. If not, the next best AP is selected and again it is checked whether that one is available, and so on, until at Step 230 the client connects to an AP.

While the client device is connected, at Step 235 the device checks the quality of the connection. If the connection is below a set quality threshold, the system reverts to Step 200 to select another service. According to embodiments of the invention, quality of connection may also take into account bandwidth loading. For example, in situations where many AP's are available and many users are present, it often happens that most users use one specific AP, e.g., the first listed AP. Consequently, one AP may experience high load, while others low load. Therefore, it may be the case that one AP may have lower radio reception strength, but be very lightly loaded so that it would be preferable to choose such an AP over one with high reception strength, but which is heavily loaded. The client according to the embodiment of the invention therefore checks load in addition to other connection quality parameters. If the connection quality is acceptable, at Step 240 the client checks whether the device is in downtime, i.e., there is a lull in communication between the device and the network. If so, at Step 250 the client measures parameters of other available AP's and at Step 260 the client reports the measurements to the server 110. At Step 270 the client receives an update from server 110, which may includes data obtained from other clients and sent to the server 110, and use that update to update its local database 126.

The server 110, on the other hand, continuously receives measurements from various clients that are connected to access points. The server 110 uses the measurements from the clients to update the database 150. In this manner, the database 150 is enhanced and continuously updated to include up to date data on any AP's that were newly put to service, modified, or removed from service. This data is sent to the clients so as to update each client's database. However, in order to conserve resources, according to one embodiment, only data relating to AP's in the client's general neighborhood is sent. According to another embodiment the user can indicate for which geographical area the user wishes to obtain updates. In this manner, for example, if the user intends to take a trip to a different location, the client can request an update of available AP's at the destination location beforehand. Similarly, if the user often commutes between two or more locations, the user may request constant updates for these indicated locations.

As can be seen from the above, according to the embodiment of the invention, individual user's clients exploit gaps in traffic communication to execute radio measurements on radio resources (ex. WiFi access points) in their neighborhood (i.e., resources “in reach”) to evaluate their ability to provide broadband access. According to one particular embodiment, this evaluation goes way beyond the normal RSSI/security evaluation done by typical WiFi clients. Specific example of such evaluation will be provided further below. The client's measurements reports are relayed to network server, so that the historical radio resources database (i.e., slow varying data) is gradually expanded and updated at the network server.

When clients send new measurement data, the clients' reports and historical radio resources data are used by the evaluation module 260 to determine quality and accessibility of radio resources. This determined data is selectively transferred to individual clients. The clients use this data to update their local radio resources database 126, so as to enable selecting the best radio resource available and executing quick connection. That is, as will be described below, the connection process is expedited by reducing the number of connection steps. As can be understood, as users connections number and quality increases, more reports are generated, thereby leading to further improvement in radio connections. As a result of this process, clients are able to:
a) Establish control signaling with network servers;
b) Allow individual client to select the best radio connection;
c) Facilitate quick and reliable connection through predetermined connection parameters;
d) Provide an updated radio resources geographical map with connection likelihood. This map could be displayed on a laptop, PDA, cell-phone, etc., upon request; and,
e) If current connection quality gets below minimum level, automatically switch connection to a better radio resource. In most cases, connection is established without any user intervention: once user initiates a network-based application (e.g., access to websites, playing games through the web, using IM, sharing files, making IP call, etc.), the system executes automatic Internet connection (AutoConnect). The automatic connection can be implemented by continuously or periodically executing the loop of Step 235 of FIG. 2. The user may also access the connection facility manually through an application control window.

According to embodiments of the invention, network clients continuously collect radio resources information. These clients could be executing on laptops, handheld devices (PDA's, cellphones, etc.), or any other devices that incorporate radio facility, such as WiFi. For example, laptop based clients can conduct radio survey while the laptop is on. Handheld units can execute this function either while activated for Internet use or while idle (i.e., in the user's pocket). On the other hand, this function may be disabled or not available when the client is running on a handheld device. Each active user terminal should be able to conduct radio resources' survey whenever it is in use. This is achieved by “measurement trips”: the client is directed to associate with an AP other than the one used for current Internet connection, and conduct data acquisition as described below. These “trips” are executed while no time-sensitive traffic is performed, so as to avoid degradation of the user's experience, as described below.

Notably, the actual rate of measurement trips per user needed decreases as the user population grows. For example, if only one user is present at a given geographical area, but several radio resources are available, a relatively large number of trips would be required to provide sufficient data to properly characterize all of the available radio resources. On the other hand, if one hundred users are present in that geographical location, it may be sufficient for each client to perform only a single trip, which from the sever perspective would amount to one hundred trips.

According to an embodiment of the invention, the following parameters are collected and reported by clients as a result of a “measurement trip”:
Backhaul quality (estimated bandwidth connection to Internet);
Gateway and DNS IP addresses;
Captive portal status (i.e., does AP have captive portal?);
AP security status (e.g., free, WEP, WPA, WPAII); and,
Estimated location (i.e., when the client determined its own location).

The above information is tagged by information acquired as part of the standard 802.11 scan, i.e.,:
Network name (SSID—service set identifier); and,
Radio MAC address.

According to embodiments of the invention, in order to acquire the radio resources parameters, each trip includes either complete or partial wireless Internet connection. The measurement/connection process may incorporate up to six phases, or any combination thereof:
F1—Basic 802.11 association procedure (inclusive of WLP, if needed); either using beacon information or probing to get association information. Being short duration, this operation may be repeated frequently. The rate of successful associations provides a good indication of signal quality and low radio interference.
F1.5—Once F1 is successful, static IP is selected for higher layers (OS, applications), for example, as described in previous patent application U.S. Ser. No. ______, filed on ______, and entitled “Masking Changes for Seamless Roaming in Heterogeneous Networking,” which is incorporated herein by reference in its entirety. In response to this assignment the OS generates an ARP (address resolution protocol) and waits until the ARP response. This phase may take a hundred of milliseconds.
F2—802.11 authentications; (WPA, WPA2 . . . ). Authentication is normally time consuming and with high duration variability. This phase may last few seconds (depend on AP firmware implementation).
F3—DHCP (Dynamic Host Configuration Protocol)—discovery operation to provide the network gateway (GW) IP address, subnet mask values and optional DNS address. GW value is essential for generation of appropriate static IP address to allow Internet access (IP value must be selected within the space defined by the GW IP address and its associated mask). DNS value may be essential but could be obtained by other means.
F4—Obtain static IP value. This IP value is exposed to the network and not to the higher layers above. This IP value is verified by generating an ARP (with the selected IP address) on the host network. In addition, another ARP with gateway address is generated to update the OS ARP table.
F4.5—This stage includes three steps:
Send ping with “time to leave” (TTL) equal 3. This ping will test response of the subnet gateway and the next two network nodes behind it (upstream). If all pings are responded, Internet connection is verified.
HTTP request to network server is generated to discover captive portal: if a captive portal exists, the HTTP message will be “hijacked” and re-direction indication status destination is returned.
UPDP (Universal Packet Driver Protocol) frame is transmitted through ports 53 and 80 to a dedicated server to check Internet connectivity. Transmission success is evaluated after returning to the active connection and asking the server (“cache server”) if the message properly arrived.
F5—Setting firewall status and allowed bandwidth consumption. Firewall can be set to one of three states:
Block everything (status=0)
Allow Internet access only (status =1); normally used by visitor firewall to prevent access to shared AP subnet resources (printer, etc.).
Allow access to Internet and subnet (status=2); normally used by AP owner allowing access to subnet resources.

The success/failure of the “F” steps and actual duration times required to accomplish each of the “F” steps is combined in “F-timing vector”. This information can be used to characterize an access point's behavior.

The radio resource database 150 stores data on all radio access points (WiFi and others) that have been discovered or registered by the users community. User's client may access this information as necessary to:
Review potential wireless Internet connection resources on geographical presentation (map, aerial photos, etc.);
Select local usable wireless connections out of 802.11 scan results.

The above information is used to build and expand the radio resource database 150. The database 150 includes list of APs reported during previous scans, measurement trips, and user AP registration (user registering an AP can set the percentage bandwidth that can be shared). Each database entry is indexed by SSID and MAC address and may include:
Backhaul quality (estimated bandwidth connection to Internet);
Gateway and DNS IP addresses;
Captive portal status (i.e., does the AP have captive portal)
AP security status (e.g., free, WEP, WPA, WPAII);
Estimated location (when the client determined its own location);
“F1” to “F5” success rate;
“F1” to “F5” average execution periods; and,
Percentage allowable shared bandwidth.

According to one embodiment of the invention, each report is also time stamped. Time stamping can assist in ensuring that data sent to clients is based on currently reliable information. For example, a time period may be established after which a report received from a client is discarded. Alternatively or in addition, a weighted system may be established so that the importance of a report diminishes with time, and most recent reports from a client get the highest credence.

The process of wireless connection to Internet can be substantially shortened when user terminal “knows” connection information before a connection attempt is executed. For example, when the terminal knows which of multiple APs has a good backhaul it can select the right AP for connection, thereby avoiding connection testing and “re-tries”. If the terminal knows what IP address will be acceptable while connecting to a specific network, DHCP (Dynamic Host Configuration Protocol) process can be avoided thereby saving substantial amount of time. For each connection procedure, the client may execute all or part of the listed “F” steps”. In a standard system (ex. Windows) all “F” steps must be performed since no information regarding accessed network is known beforehand (safe assumption for distributed network with independent clients). Sharing centralized radio resource information with each client allows shortcuts: the more information is known to clients about the selected access point, the number of “F” steps can be reduced, hence connection time minimized. Typically, when the AP is already part of radio resource database, only F1 (association), F2 (WPA exchange) and F4 are needed, thereby substantially reducing the average connection time. When the number of users increases, F4 can be shorten as well (eliminate ARP function). Reduced connection time allows seamless connection switching (roaming) without centralized control.

To illustrate, it is well known in current computing system to cache information related to access point to which the mobile device has connected before. In this manner, when the mobile device is activated at a later time in the same locale, the system uses the information in the cache to automatically reconnect to that AP. The cache normally includes the name and the MAC address of the AP. However, when the mobile device is activated in a new location, it has no information in the cache to enable fast connection to an AP. According to an embodiment of the invention, when clients send connection reports they also send the cache information. Then, the server sends cache information to each client, relating to all AP in the vicinity of the client or in a geographical area requested by the client. In this manner, the mobile device can have cache information of AP's to which the mobile device was not connected before. Thus, for example, if a user travels to a new location, the user can indicate the travel destination and the server would transmit cache information relating to AP's at that geographical location. Then, when the user reaches that location, its mobile device can use the information in the cache to easily connect to AP's in the destination location.

To expedite wireless Internet access, radio resource information that has been accumulated and processed at the network server must be distributed to user terminals (clients). According to an embodiment of the invention, the distribution to clients is made of only information that is relevant to each specific client. According to one specific example, relevant radio resource information is distributed based on the client's geographical location. The client's geographical location is defined as the location at which last Internet connection had been established; e.g., home, office, free hotspot etc. The network can determine clients location using few alternate methods, most notably IP location services. IP location service can locate the client to city, neighborhood etc. Hence relevant radio resource information may be relevant to same city or neighborhood. Although this approach may not be sufficient when the client is relocated between cities, client's autonomous connection capability can establish first connection in a new place and facilitate first radio resource information distribution. Thereafter, the client executes the processes described herein to obtain data about radio resources in that specific geographical location. Additionally, as described above, the user may indicate a specific geographical location for AP update.

Connecting to wireless network starts by scanning the neighborhood for candidate connections (802.11 scan). The 802.11 scan produces a list of access points in reach; for each intercepted access point radio signal strength indication (RSSI) is provided along with type of security status. The connection process will exploit the radio resource information in its memory. Next, the client selects the most favorable access point for connection in the following order:
If “favorite” AP (AP is called favorite if it is part of radio resource database that had been distributed to client, or user manually added it to the favorite list) is detected by “802.11 scan” and the RSSI is above predetermined threshold (ex. Owner's AP), the client selects this AP for connection, or
If a list of previously successfully used access points is available (locally stored) and some APs out of the list are available and their RSSI is above predetermined threshold, client will select the highest RSSI value-AP out of the list for connection, or
If an one or more APs that are registered as collaborating APs are present and their RSSI is above predetermined threshold, client will select the one with highest RSSI, or
If only free (non-secured) APs are present and their RSSI is above predetermined threshold, the client will select the highest RSSI AP first and if connection cannot be made, will select the next highest RSSI AP and so on, until connected.
If only captive portal APs are present and captive portal parameters their RSSI is above predetermined threshold, select the AP with highest RSSI and connect.
If after the above process no connection is achieved, client declares “no connection possible”.

As mentioned above, the connection process (F1 to F5) is being shortened as much as possible depending on whether radio resource information regarding the target AP is already known.

As described above, procedure F4.5 allows identification of captive portal existence. When user tries to access a captive portal for the first time, his request for specific site (normally through browser launch) is hijacked and a captive portal page is presented. The user then must enter various information elements as prompted by the captive portal page. This session can be recorded by the client and cached for future connections to same portal. When the device tries to connect to the same portal again, the client can automatically carry the session. This action relives the user from the need to handle lengthy interaction with the portal when connecting. Sometimes not all information transactions can be automated (ex. CAPTCHA verification by typing distorted letters). In this case, some user interaction (entering some data) may be needed. In addition, the session details can be sent to the network server to be cached for other users in network server's captive portal database. For each captive portal name a transaction script is stored. A localized version of this database exists at the client as well. The client's database contains a fraction of the network server's database: captive portal that are in its neighborhood. When a user is connected to Internet, its local captive portal database scripts is getting updated based on its speculated neighborhood. The speculated neighborhood is determined based on the location of the current Internet connection. The user; however, can update its captive portal database manually by defining the desired neighborhood.

The network server uses the clients' reports to determine AP accessibility and potential service quality. The AP Quality and accessibility (Q&A) vector is encoded into radio resource database entries. It is essential to make this information very concise to minimize the traffic load when updating the clients' local radio resources database. These entries are stored at the network server database 150 based on location coordinates sorted to “wireless regions.” Radio resources regions are geographical areas such as cities, parks, groups of cities, states and other geographical areas of interest. The radio resources are sorted to these regions based on location coordinates reported by the clients (ex. IP location method). Obviously the regions' sizes can vary dramatically. The number of regions can change over time to reflect radio resources distribution and other factors. APs are sorted by MAC address and/or SSID. Combining SSID and MAC address provides a more robust (unique) indexing. Each AP's Q&A vector includes as follows:
Connection Quality;
Ease of Accessibility;
Gateway IP & mask;
Time Stamp (optional); and,
Location coordinates (optional).

Connection quality may be calculated based on first and second order statistics of ping delay, RSSI, achieved data rate (over all clients' reports):

$$ConnectionQuality = Q \cdot \frac{mean ( RSSI ) \cdot mean ( dataRate )}{var ( pingDelay ) \cdot var ( dataRate ) \cdot mean ( pingDelay )}$$

Accessibility is defined in two stages:
Accessible/non-accessible; and,
If accessible, “ease of accessibility” is calculated based on statistics of: success of F operations rate and F-timing vector value (over all clients' reports) weighted by security status and availability of password.
   Ease of Accessibility=A*(Connection Success Rate/Mean (Connection Time))

Upon first time login, selected region of radio resources database (based on client's estimated or reported location) is downloaded into the client. This information can be downloaded in sections starting with immediate neighborhood region and gradually (as time permitted) larger regions. Client radio resource database may be updated when:
AP in server database section (region) that is relevant to current client's location has changed by more than a certain update threshold since last update. To minimize traffic it is beneficial to load only the changes since last update.
The client moved to a different radio resources database region.
The client's database is empty or has been erased.
The client has requested an update.

When client is becoming active it executes 802.11 scan (for APs in reach: RSSI, security status). Using the MAC address the client can compare this scan results with its radio resources database to determine which APs are preferred for connection and roaming.

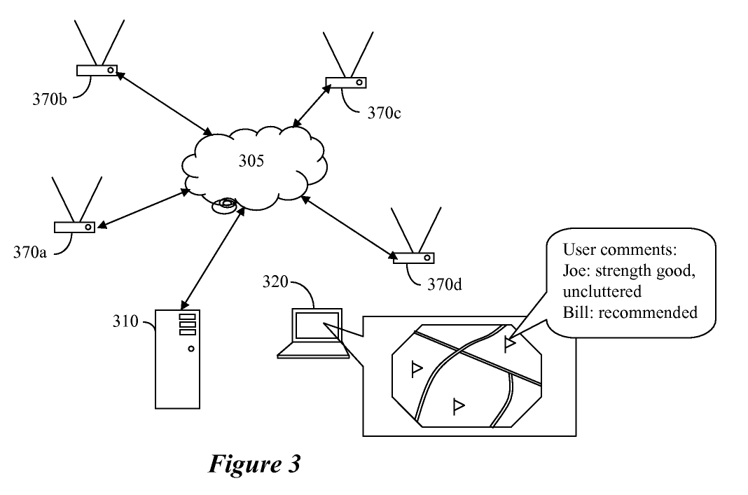

According to an aspect of the invention, the access method and apparatus can be implemented as a social network. One issue observed by the inventor is that generally owners of radio access points are averse to sharing the AP resource with people they don't know. However, if there has been certain a priory contact, owners are much more likely to share the resource. Such an a priory contact may be made in the form of a social network. FIG. 3 is a schematic illustrating a social network according to an embodiment of the invention. In FIG. 3, a computing resource, such as server 310, and radio access points 370a-d are connected to a network 305, such as the Internet. In this embodiment, access point 370d belongs to a user who also uses access device 320, such as a laptop, a PDA, etc. The user generally is able to access the Internet 305 by connecting device 320 to access point 370d wirelessly. As is known, access point 370d operates to a certain range, which may generally allow other users to receive the signal of access point 370d. As explained above, the security of access point 370 may be set to allow no access, allow limited access, or allow all access, by the choice of the owner. When the owner registers access point 370d as member of the social network, the owner may specify the amount of bandwidth the owner is willing to allocate to third parties who are in the vicinity of the access point 370d. The owner may specify other parameters, such as access password, etc. When third parties connect to access point 370d, their client report connection data of access point 370d to the server 310. In this manner, relevant and updated information regarding access point 370d is stored in the database of server 310.

Conversely, when the owner of device 320 is away from its own access point 370d, the client of device 320 queries its database to determine which member's access point is available and at what connection quality. The client then connects the device 320 to the preferred access point. The client then sends connection information to the server 310 to update its database. In this manner, by agreeing to provide connectivity via its own access point, the user is able to obtain access to the network when the user is away from its own access point. That is, other members in the social network will allow the user to access the Internet via their access points. Moreover, a database is built which stores relevant and updated information regarding the location and quality of all members' access points. In this way, availability of radio access point is increased and connection to access points is improved.

FIG. 3 also depicts in the callout a feature of the invention wherein a geographical map is provided to device 320 to indicate locations having radio access point. As shown in the callout, a map of a delimited geographical area is depicted, and flags are used to indicate where radio access points are available. While flags are used in this example, any other shapes may be used. Additionally, according to a feature of the invention, the flags are colored in different colors according to their access quality. For example, the colors may change from green to red, wherein green is excellent access quality while red is poor. Additionally, or instead, numerical indication may be included in the flag to indicate the quality ranking of the access point. Both color and ranking may be used.

Moreover, the ranking may reflect both the quality of the access point in general, and the ranking of the access point with respect to the specific location the user is presently situated at. That is, access quality may change depending on the location of the mobile device with respect to the access point. However, location of mobile devices may be a repeatable event. For example, many users may frequent a specific restaurant or coffee shop. Therefore, it is very likely that previous users visited the same establishment and the client on their mobile device sent a report about the connectivity to the access point from that specific location. Thus, when the server determines the location of the mobile device of the user, the server may present a ranking of the access point with respect to the specific location of the mobile device.

Receiving ranking from many users about various AP's in the vicinity of the user may be very helpful in establishing a connection when many AP's are available. As experienced by many uses, when many access points are available, users generally simply try to connect to one after the other until success is achieved. However, if it is known beforehand that one specific point is available and is reliable, it would be more efficient to devote the efforts to connect to that specific AP. By having the ranking on the map, which may reflect reports from various other users, one is able to better select the AP to access. Furthermore, by having the map beforehand, one may chose one location over another. For example, one may prefer one coffee shop over another by noting on the map that one coffee shop is situated for better Internet access.

In one embodiment, where the system is implemented in the form of a social network, users may be able to also send comments on a specific AP in addition to the client's reports. In this manner, users are able to observe AP's rating generated from various clients' reports, and may also read comments of users. For example, if one specific commenter is known from experience to be reliable and write informative comments, it would make selecting the proper AP more easy and efficient by following his suggestions. According to one implementation, the comments may be accessible by clicking on the flag of a particular AP of interest or by simply positioning the mouse over it (“mouse over”) so as to open a secondary window, as shown by the secondary callout in FIG. 3.

As will be described below, the WCF leverages the system described in the previous paragraph to provide seamless WiFi connectivity. According to features of the inventive WCF, anytime the user device is close enough to a WiFi access point (that can provide Internet access) and Internet connection is needed, the WiFi radio would be activated and the device will automatically get connected to Internet. When connection is no longer required, WiFi connection will be automatically severed and the broadband radio turned off in order to conserve power.

According to further benefits of the inventive WCF, seamless WiFi roaming is enabled. When current connection is no longer sufficient (user moves away form access point, traffic load on access point is excessive, etc.) the WeFi client will disconnect from current WiFi access point and reconnect to best available connection point. This connection change will be transparent to the user and running web application. The WCF further provides seamless roaming between WiFi and cellular network connections. When WiFi connection fails, the client running on the handheld device will automatically switch to cellular connection and visa versa. This behavior depends on user preferences (cellular connection may be avoided following user's request, e.g., when cellular provider charges for data transport and user desire to avoid those). The WCF also provides geographical location of the user and other WeFi members. If the device (user) location is needed, e.g., for some social networking application, the WCF will automatically determine the location and make it available to application. This is done even when GPS data is not available.

To enable the above functions, according to one embodiment the following services (API's) are utilized:
Communication socket services:
   Open access to Internet
   Create socket to defined destination
   Transmit (parameters: buffer, destination).
   Receive (parameters: buffer, source)
   Close socket to defined destination
   Close access to Internet
Location services
   Get current terminal's location
   Get location of specified user (parameters: user ID)

The following scenarios may help clarify the above noted features and services. The related operations will be described in further details below. According to a first example, it is assumed that the user's handheld device is set to have its WiFi radio turned off, and is communicating only via its cellular transceiver. The user then launches a web-based application within a browser on the handheld device. The application requests broadband connection by sending a message to a server (part of device's WeFi client, WeFi server or application server.). When the application sends the message via the cellular network, it is handled in a conventional manner; however, when the application attempts to send the message over broadband connection, the request is rerouted via the cellular network. For example, a WeFi client may highjack the request and send it via the cellular network.

When the application server (herein “server”) receives the request, it notifies the WeFi server of the request. This may be accomplished over a landline. The WeFi server then sends a message to the WeFi client on the user's device, instructing it to turn on the broadband radio and establish connection to an available access point. Once the WeFi client establishes a broadband connection it instructs the application to communicate via the broadband radio. If the client cannot establish a broadband connection, e.g., no access point is available, the client sends a proper message to the WeFi server and may display a proper notice to the user. The WeFi client may then either turn off the broadband radio, intermittently attempt to reconnect, etc.

Once a broadband connection is achieved, the system uses “keep-alive” messaging to maintain WiFi connection. If no web application on the device is active for some predetermined period of time, the WiFi connection is dropped and the broadband radio is turned off in order to conserve battery charge. If for any reason WiFi connection is dropped during a session, the WCF will automatically look for another viable WiFi resource and connect to it. If no adequate resource found, WCF will signal the application and may display a “no WiFi” message to the user.

Seamless roaming is very important for mobile devices for couple of reasons, i.e., maintaining an on going session while moving around, and increasing the effective service coverage and speed. According to embodiments of the invention, when a current WiFi connection's quality is deteriorating, the WeFi client tries to exchange the connection. A new connection is selected based visible WiFi radios and prior quality information provided by the WeFi server. According to one embodiment, the process proceeds as follows. Once current connection is severed, the WeFi server informs the application server about the connection drop. The WeFi client executes a new WiFi connection (if an access point becomes available). If new connection is not available, the WeFi server informs application server “connection not available”. Based on user preferences, the user destination address is switched to the cellular connection (gateway). Warning is then issued to user. If a new connection is available, the WeFi server provides the application server with new user destination address, allowing continuous service.

Many social network applications make use of user location information. The application sever can get users' locations and other geo-information from the WeFi server as follows. The user requests a map of his neighborhood (ex. Google map). The application (that uses Google's map APIs) requests the user's location form the WeFi server (using WeFi's user ID). The WeFi server returns the user's location and the application can than request the relevant map from Google or other provider.

We turn now to embodiments exemplifying implementations of the inventive aspects of the invention. As observed by the current inventor, the majority of rich content applications are web based. This means that they are running within browser environment. Consequently, interfacing between terminal resident application (YouTube, MySpace, Google Maps, etc.) and another program running on the same device may be problematic. Therefore, according to one embodiment of the invention, the WeFi communication manager is a non-web application program, enabling it to execute when there is no Internet access. As such, enabling direct interaction between browser based application and WeFi program/client may not be feasible. Instead of direct interaction, in this embodiment an interface is established between the web servers that support the application and the WeFi client.

The following embodiment of the invention leverages the dual mode ability of the handheld device (cellular & WiFi) and the WeFi's client-server architecture described above with respect to FIGS. 1-3. Instead of direct connection between the browser based application and the WeFi client, signaling communication is routed between the application server and the WeFi server. This approach enables web applications to control the WiFi connection. For example, activating the WiFi radio only when rich content (video clip, pictures, etc.) is ready to be transmitted and deactivate the WiFi radio when not needed. This capability can greatly extend the handheld device's battery life since WiFi logic and radio greatly impact power consumption.

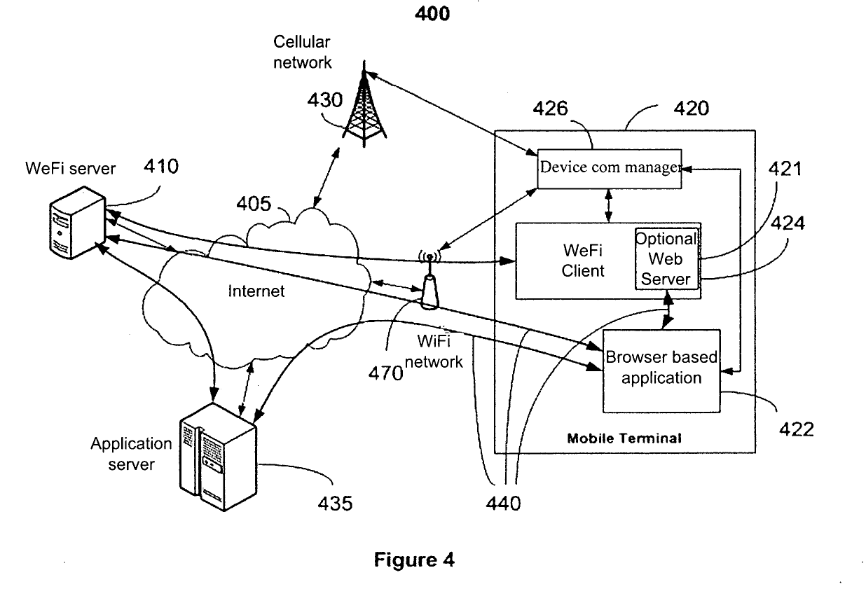

FIG. 4 schematically illustrates system architecture 400, according to an embodiment of the invention. In FIG. 4, handheld device 420 accesses the Internet 405 via cellular network 430 and/or access point 470. Access point 470 may generally be a broadband access point using, e.g., a WiFi transceiver. The handheld device runs a communication manager 426, a WeFi client 424, and Web-based, e.g., browser based, applications 422, such as, for example, YouTube, iTunes, etc. Application server 435 may be any server supporting the Web-based application running on the handheld device 420, e.g., Yahoo! server, YouTube server, etc. WeFi sever 410 may be a server similar to servers 110 and 310 described above and supporting the WeFi client 424 running on the handheld device 420. The handheld device 420 may communicate with application server 435 and WeFi server 410 via either the cellular network 430 or WiFi access point 470. WeFi client 424 may incorporate a partial web-server allowing local browser application 422 to communicate directly with it. Generally each web-application or client should be able to use HTTP protocol to converse with all servers.

According to one embodiment, the invention leverages conventional web cookies to bind user ID and browser. WeFi client 426 can send link to WeFi server 410 which returns a cookie with the user ID. At this point the browser “has knowledge” of the user ID associated with the same device WeFi client. Once the browser “runs” a web application, the associated web server can ask for this cookie and get the user ID information. Now the browser can bind the desired WiFi radio and the respective application.

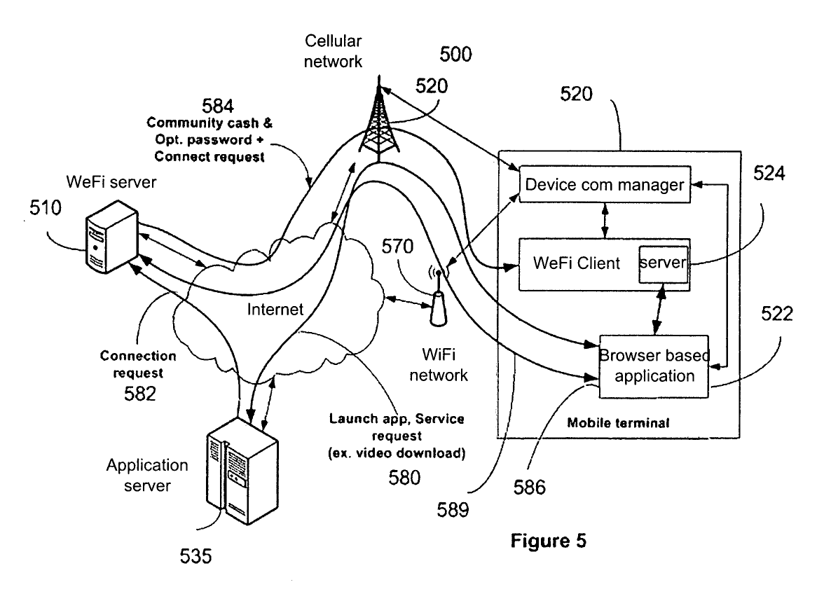

Turning to FIG. 5, an example of an Internet connection procedure according to an embodiment of the invention is illustrated. The system 500 shown in FIG. 5 is similar to system 400 shown in FIG. 4. When WeFi client starts it may send a “HTTP get” to WeFi server that along with the response may send a cookie to the client. This Cookie may include WeFi user ID hence the terminal's browser knows the local WeFi client user ID. The user than launches the web-based application in same browser 522. The browser 522 sends message 580 to the application server via the cellular network 530. The application server may host a home page for the browser, e.g., Yahoo!, MSN, Google, etc. When the application server identifies a pending rich content transaction (download, upload, streaming, etc.), it can retrieve WeFi user ID from the cookie in the browser and send a connection request 582 to the WeFi server 510 with the WeFi user ID. Request 582 may be transmitted over the Internet using wired connections and may include the source IP address, i.e., the IP address of the mobile device 520. The WeFi server 510 then sends a message 584 to notify the WeFi client 524 based on the WeFi user ID. The message may be sent to the source IP address received from the application server 435. Notification 584 may be sent over the cellular network 530 if a WiFi connection has not been established yet with the handheld device 520 (e.g., WiFi radio is non-active).

In another embodiment, as described in FIG. 4, WeFi client 520 may include a web server able to directly converse with web-application 522. In this case once web application identifies a need for broadband connection, the web application can signal the need directly to the WeFi client using HTTP protocol with “local host” address. This arrangement simplifies the WiFi control process and may substantially reduce the request delay. However, some browsers may prevent direct connection to host PC for security reasons.

In another embodiment the web-application in browser 522 may send broadband connection request 589 directly to WeFi sever 510. In this case WeFi sever can ask for the WeFi cookie to get the user ID and subsequently send WiFi activation or deactivation request 584.

According to one embodiment of the invention, the connection request 584 sent from the WeFi server 510 to the WeFi client 520 includes information related to WiFi resources (access points) in the device's neighborhood. For example, the request may include data relating to which access points 570 may be available for connection, what transmission quality to expect, WPA password, etc. This information is created by the WeFi community as explained above with respect to FIGS. 1-3, and is therefore called “community cache.”

Once the WeFi client 520 receives the connection request 584, along with the related resources information, it can quickly activate the WiFi radio of the handheld device 520, and connect to WiFi network if available. According to one embodiment, a confirmation message may then be sent over the WiFi connection to the WeFi server 510 or to the application server 535. According to another embodiment, no confirmation message is sent. Once the WiFi connection has been established, the application server 535 may transmit the requested data (video, images, etc.) to the handheld device 520 via the WiFi access point 570.

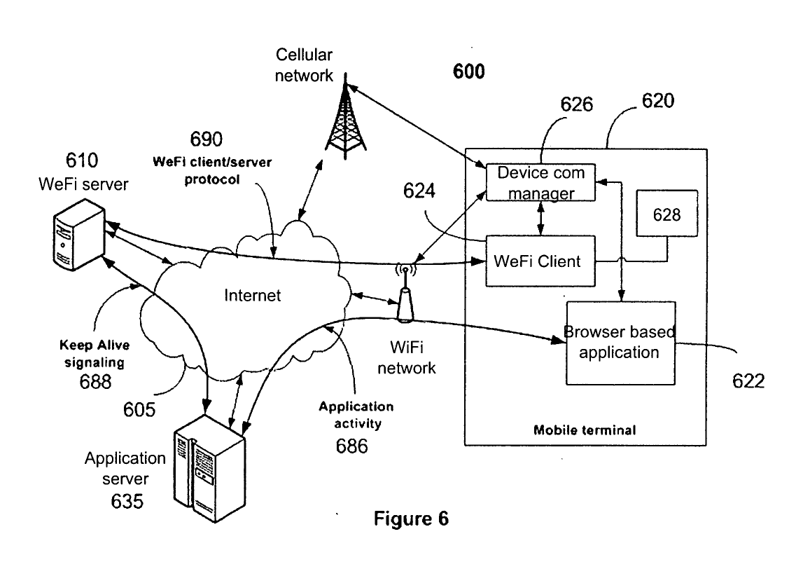

According to another aspect of the invention, the system uses “keep-alive” messaging to maintain WiFi connection when needed. However, if no Web application on the device has been active for some predetermined period, the WiFi connection is dropped and the broadband radio turned off for power saving. On the other hand, if for any reason the WiFi connection got dropped while an application is still active, the WeFi client will automatically look for another viable WiFi resource and connect to it. If no adequate resource is found, the WeFi client will signal the application and may display a “no WiFi” message for the user. An example of such a feature is described below with reference to FIG. 6.

FIG. 6 illustrates an example of WiFi connection maintenance according to an embodiment of the invention. The example is illustrated with respect to system 600, which is similar to systems 400 and 500. As can be understood from FIG. 6, as long as handheld device 620 communicates with application server 635 (application activity 686), the connection with an access point 670 should be maintained. Accordingly, application server 635 and WeFi server 610 exchange “keep alive” signaling at all time that activity 686 is sensed by server 610. If connection to access point 670 is lost, the WeFi client 624 informs the WeFi server 610 (WeFi client/server protocol 690). The WeFi server 610 then notifies the application server 635, so that the application server 635 would change the behavior of the application. For example, if the user allows usage of the cellular network 630 as an alternative, the application will continue operations using the cellular network 630 connection. Of course, if the WiFi connection is severed and other WiFi access points are in reach, the WeFi client will look for alternate WiFi connection. Once connected again, a connection signal will be generated to the application server 635 via the WeFi server 610.

In the case where multiple Web-based applications 622 are running on device 620, the WeFi server 610 will sum-up all the keep-alive signals. Once the keep alive signal is not generated by any of the applications, the WeFi server 610 sends a WiFi-OFF message to the WeFi client 624 (either through WiFi access point 670 or cellular connection 630).

In case of direct connection between web application 622 and WeFi client 624 serving as local host, WeFi client may sum up the keep alive signals form all web-applications running within the local browser.

A major Achilles of any cellular system is the handover process. Current connection may deteriorate for various reasons (user moves away from access point, access point may be overloaded, etc.). To avoid service interruption, one must find an alternate connection as fast as possible. However, the WiFi system was never designed to support this kind of operation. Being a simple IP based solution, joining a network is a lengthy process: association, authentication (WPA, RADIUS), DHCP and ARP. Being a single radio system, handover is forced to be performed by a “break before make” process: the WiFi terminal must disconnect from one access point before engaging with another one. Without some prior knowledge regarding the alternate WiFi resource in reach, the handover can be rather difficult: WiFi terminal may try to connect via unusable WiFi access point and handover may fail. Being not connected to any source, resuming any connection may be very hard or even impossible thereby loosing the whole session.

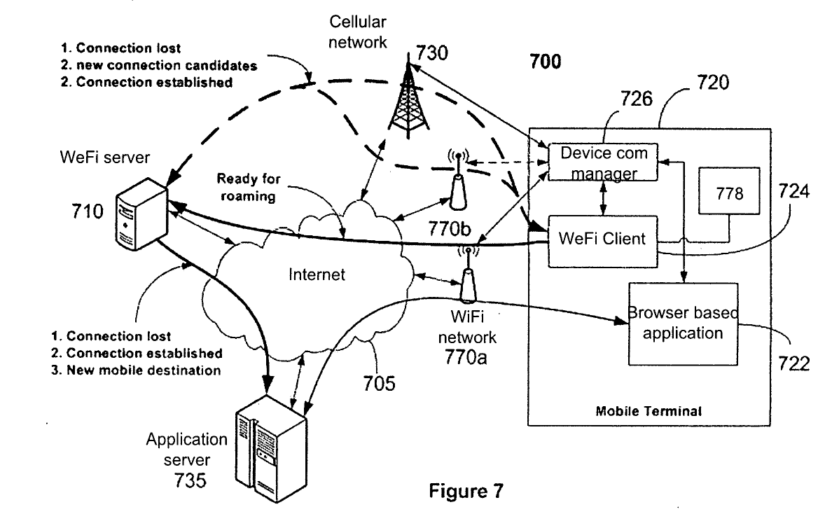

According to an aspect of the invention, the cellular connection is leveraged to avoid the above issues. Since cellular connection is assumed to be always there, control signaling can be executed over this connection, substantially improving the handover reliability. FIG. 7 illustrates an example of a roaming process according to an embodiment of the invention.

The example of FIG. 7 is illustrated with reference to system 700, which is similar to system 600. As with FIG. 6, so long as a Web-base application 722 is active on the handheld device 700, WiFi connection to access point 770a should be maintained. Before or at the time that the connection with current access point 770a deteriorates, the WeFi client can ask the WeFi server 710 for update on alternate WiFi access points in the neighborhood. When the WeFi client 724 identifies an access point e.g., 770b, that is seen with some higher-level signal and confirmed by the WeFi server 710 as usable, it can establish the alternate connection via the new access point 770b. If, for any reason, the handover fails, the WeFi client 724 can report to the WeFi sever 710, try another usable access point, or ask for more information. This process can continue over the cellular connection 730, until a new connection is established. Also, While the WiFi connection is not available, the cellular connection 730 can be used (although with less performance) to service the application 722. This will maintain service continuity when WiFi service is not available.

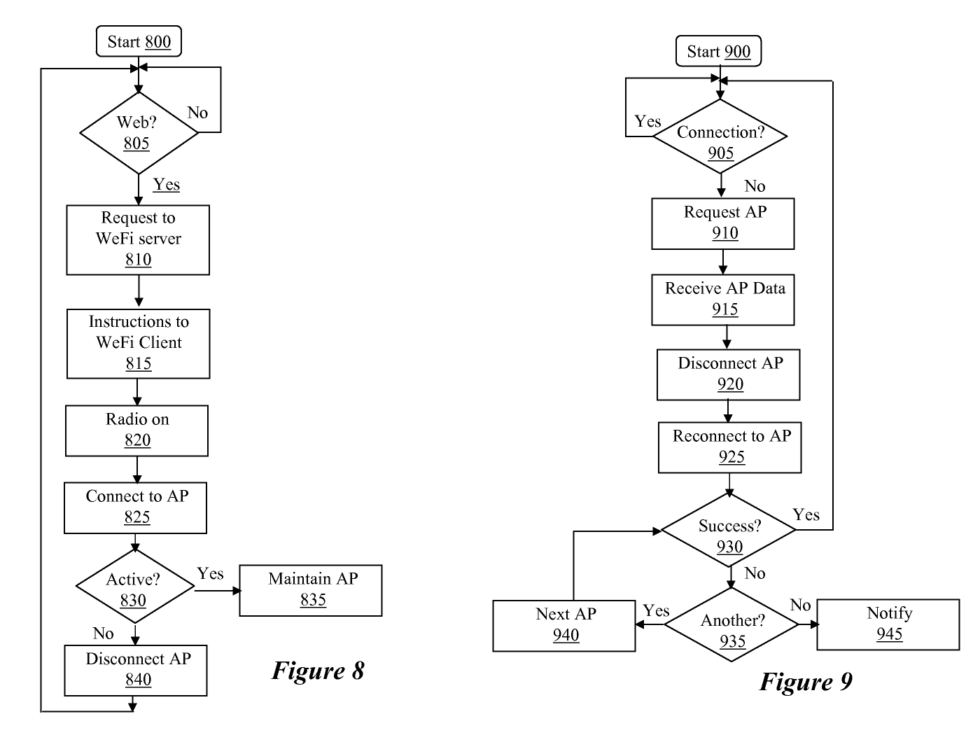

FIG. 8 illustrates a flow chart of a process according to an embodiment of the invention. In FIG. 8, after the process starts in 800, it proceeds to check whether an application requires a WiFi connection (805). If not, no step is taken and the method simply proceeds to monitor for a requirement for WiFi connection. If a requirement for connection is sensed, e.g., a browser sends a request for a webpage or data download (e.g., video, picture, audio file, etc.,) from a website, at 810 the application server sends a request to the WeFi server to indicate that the requesting handheld device requires a broadband connection. As can be understood, the request may include identification of the particular handheld device. If the said server is part of the WeFi client, the terminal ID is obvious.

When the WeFi server or the server embedded in the WeFi client receives the request, it sends a notification to the WeFi client (815). The client then turns on the broadband radio (820) and then establishes connection to an available access point (825). At 830 the process monitors whether activities on the handheld device still necessitate broadband connection. If so, the connection is maintained at 835, according to, for example, the method discussed below with respect to FIG. 9. If no such activity is sensed, then the connection to the access point is terminated at 840 and the process reverts to step 805.

FIG. 9 illustrates a process according to an embodiment of the invention for maintenance of connection. In FIG. 9, after the process starts at 900, it checks whether the connection is of sufficient quality (905). If so, it simply reverts to continue checking the connection quality. When it is determined that the connection quality is below a set level, or has been lost, a request (910) is sent to the WeFi server to obtain data relating to available access point at the vicinity of the handheld device. The geographical location of the handheld device can be deciphered automatically by checking the database in the WeFi server to obtain the geographical location of the access point to which the handheld device was connected (refer to description of FIGS. 1-3). The WeFi server then fetches data relating to access points in the vicinity of the handheld device and transmits it to the WeFi client. When the WeFi client receives the access point data (915) it checks to see whether preferred access points are available for connection. If so, the client disconnects from the current access point (920) and attempts to connect to the preferred access point (925). If the connection attempt was successful (930), the client reverts to monitoring the connection. Otherwise, it checks whether another access point is available (935). If another access point is available, the client attempts to connect to it (940). If none is available, the client may notify the WeFi client (945), so that it in turn notify the application server, so that the communication with the application may proceed using the cellular network, if allowed by the user.

As can be understood from the above description, the inventive system and method exploit the following elements to improve rich content transmission:
1. WeFi client server architecture;
2. WeFi “easy-access” method; and,
3. Dual mode (cellular & WiFi) operation in new terminals.
   The cellular channel allows for robust process control and connection continuity in a broad geographical coverage. The client server architecture allows handling the challenges of interfacing between web-applications and WiFi resources on the handheld device. The easy access method provides for robust and quick handover process in a broadband application originally not designed for handover operations.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described methods and systems may be implemented in a wide variety of programming or scripting languages, such as Assembler, C/C++, perl, shell, PHP, Java, etc.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. Various aspects and/or components of the described embodiments may be used singly or in any combination in the plasma chamber arts. It is intended that the specification and examples be considered as exemplary only, with a true scope and spirit of the invention being indicated by the following claims.

1. A processor implemented method for connecting a wireless user device to the Internet, the device comprising a WiFi radio and a cellular network transceiver, the method comprising:
operating the processor to perform the operations:
monitoring application executing in the device for Internet access requirement;
upon detecting Internet access requirement, evaluating the requirement to thereby determine whether to establish Internet connection using the WiFi radio or the cellular network transceiver;
executing the connection to the Internet according to the determination.

2. The method of claim 1, wherein when determining that the Internet connection should be executed using the WiFi radio, performing the further steps:
scanning for available WiFi access points;
selecting an access point and attempting to connect to the access point using transmission from the broadband radio; and,
if the attempt fails, attempting to connect to another access point,
if the attempt is successful, maintaining the connection so long as access requirement is maintained.

3. The method of claim 1, wherein the Internet access requirement is issued by the application and includes a preference for WiFi connection.

4. The method of claim 1, further comprising monitoring reception at the device for a message indicating WiFi Internet access requirement.

5. The method of claim 4, wherein monitoring reception comprises receiving a message over a cellular network indicating a requirement for WiFi connection.

6. The method of claim 2, wherein selecting an access point comprises:
sending data of available WiFi access points to a connection server;
receiving a message from the connection server, the message including further data relating to the available WiFi access points;
reading the further access point data from the message and connecting to the best available WiFi access point based on the data and the further data.

7. The method of claim 2, wherein maintaining the connection comprises monitoring a keep alive signal received at the device or at WiFi connection sever.

8. The method of claim 7, wherein the keep alive signal is generated by the application.

9. The method of claim 8, further comprising, when no keep alive signal is detected for a predetermined period of time, terminating the connection to the access point and turning off the WiFi radio.

10. The method of claim 2, wherein maintaining the connection comprises monitoring broadband transmission activity of the device.

11. The method of claim 10, further comprising, when no broadband transmission activity has been detected beyond a predetermined time period, automatically terminating the connection to the access point and turning off the WiFi radio.

12. The method of claim 2, wherein maintaining the connection comprises monitoring disconnection request issued by the application and, when a termination request has been received, automatically terminating the connection to the access point and turning off the WiFi radio.

13. The method of claim 2, wherein maintaining the connection comprises, when detecting unexpected connection drop, selecting another access point and attempting to connect.

14. In a communication system having an application server connected to the Internet, a network control sever that includes access point database connected to the Internet, and mobile device, the mobile device running a client in communication with the network control server, the mobile device comprising a cellular transceiver for connection to a cellular network and a WiFi radio for connecting to WiFi access points, a method of managing communication, comprising upon detecting a high bandwidth transaction, performing one or more of the operations:
i. sending a connection request from the application server to the network control server, indicating WiFi connection requirement; upon receiving the connection request at the network control server, sending connection instruction, over the cellular network, to the device; upon receiving the connection instruction at the device, turning on the WiFi radio at the device and attempting to connect to a broadband access point;
ii. sending a connection request from a web application, running in web browser on the mobile device, directly to network control server; upon receiving the connection request at the network control server, sending connection instruction, over the cellular network, to the device; upon receiving the connection instruction at the device, turning on the WiFi radio at the device and attempting to connect to a broadband access point; and,
iii. sending a connection request from a web application, running in web browser on the mobile device, directly to the client; upon receiving the connection requet at the client, turning on the WiFi radio at the device and attempting to connect to a broadband access point.

15. The method of claim 14, further comprising: when an application requiring high transmission rate is launched on the mobile device, sending a message, over the cellular network, from the mobile device to the application server indicating broadband connection requirement.

16. The method of claim 14, further comprising monitoring broadband transmission activity by the mobile device and, so long is broadband transmission activity is detected, sending a keep alive connection message from at least one of:
the application server to the network control server; and
the web application to the client.

17. The method in claim 14, further comprising sending from the network control sever a cookie with device ID to mobile device and wherein the connection request comprises data from the cookie.

18. The method of claim 14, further comprising monitoring broadband transmission activity by the mobile device and, when no activity is detected over a predetermined period, sending turn off instruction from the network control server to the mobile device.

19. The method of claim 18, further comprising, upon receiving the turn off instruction at the device, terminating the connection to the access point and turning off the WiFi radio.

20. The method of claim 14, further comprising, when no broadband connection is available, sending a no connection message from the mobile device to the access point database server.

21. The method of claim 20, further comprising, upon receiving a no connection message at the network control server, causing the application server to communicate with the mobile device over the cellular network.

22. The method of claim 14, further comprising:
sending a location request with mobile device ID from the application server or directly from web application to the network control server;
using the ID at the network control server to determined the particular access point the mobile device is connected to;
querying network control server to determine the location of the particular access point;
sending the location to the application server.

23. A mobile device, comprising:
a cellular network transceiver;
a broadband radio;
a processor;
a connection client causing the processor to perform the operations:
monitoring the device for Internet access requirement;
upon detecting Internet access requirement, turning on the broadband radio and scanning for available WiFi access points;
selecting an access point and attempting to connect to the access point using transmission from the broadband radio; and,
if the attempt fails, attempting to connect to another access point,
if the attempt is successful, maintaining the connection so long as access requirement is maintained.
